(19) United States
(12) Patent Application Publication
(10) Pub. No.: US 2011/0093955 A1
(43) Pub. Date: Apr. 21, 2011

(54) DESIGNING SECURITY INTO SOFTWARE DURING THE DEVELOPMENT LIFECYCLE

(75) Inventors: Earl Chen, Monmouth Junction, NJ (US); James R. Apple, Delanson, NY (US); Keith Gordon, Denver, NC (US); Gary D. Granza, Cornelius, NC (US); Leon S. Williams, Kennesaw, GA (US); Brian D. Nichols, Charlotte, NC (US)

(73) Assignee: BANK OF AMERICA CORPORATION, Charlotte, NC (US)

(21) Appl. No.: 12/651,649

(22) Filed: Jan. 4, 2010

Related U.S. Application Data
(60) Provisional application No. 61/252,890, filed on Oct. 19, 2009.

(51) Int. Cl. G06F 21/00

(52) U.S. Cl. 726/25

(57) ABSTRACT

Systems, methods, and computer program products are provided for a comprehensive software security system. The overarching software security system described and claimed herein provides for a system that address all of the concerns and vulnerabilities present at the design level (i.e., new software applications) and the production level (i.e., pre-existing software applications) associated with software. Additionally, the system governs the individual security processes and practices. The software security system defines specific security practices and the timing for application of the practices within the overall software development lifecycle. Additionally, the disclosed software security system takes advantage of role specialization, such as security specialization, to increase effectiveness and limit conflicts of interest within the design process.

### CLAIM OF PRIORITY UNDER 35 U.S.C. §119

The present application for patent claims priority to Provisional Application No. 61/252,890 entitled “Security by Design in Software Development Lifecycle” filed Oct. 19, 2009, and assigned to the assignee hereof and hereby expressly incorporated by reference herein.

### FIELD

In general, embodiments herein disclosed relate to systems, methods, and computer program products for software security and, more specifically, processes and systems for designing security into software during the development and production lifecycles to minimize vulnerabilities and ensure the security of custom developed software systems.

### BACKGROUND

Cyber crime is defined as criminal activity involving computers and the Internet. Unfortunately, cyber crime has become one of the world's fastest growing illegal activities. The anonymity and around the clock access afforded by the Internet, combined with a thriving and somewhat unregulated global Internet economy, has created an environment ideally suited to exploitation by hackers (i.e., individuals committed to circumventing computer security) and cyber criminals. To combat cyber crime, legitimate Internet businesses must develop their software securely to prevent illegal access and thwart attempted exploitation of customers. As a means of attempting to overcome or mitigate the risk posed by hackers and/or cyber criminals, software development organizations have been developing best practices, frameworks, processes and the like to ensure software security.

Examples of such software development organizations include, Build Security In (BSI), which is a strategic initiative of the National Cyber Security Division (NCSD) of the United States Department of Homeland Security. However, the BSI strategic initiative is a process agnostic approach to software security that instead focuses on a collection of best practices and methods that can be applied to software development approaches. Another organization, which has been developed under the auspices of Microsoft Corporation of Redmond, Wash., is Security Development Lifecycle (SDL). The SDL approach includes best practices, process improvements and measuring metrics related to both best practices and process improvements. Yet another exemplary organization is the Open Web Application Security Project (OWASP), which has developed a series of security processes under the Comprehensive Lightweight Application Security Project (CLASP) that can be implemented to increase security in software development lifecycle.

However, all of the known frameworks, methodologies, processes and best practices suffer from limitations. In some instances, the current solutions are overly general and do not provide enough detail for actual implementation. In other instances, in which sufficient detail exists, the processes are targeted at a particular activity in the software development lifecycle and do not provide an overarching process to combine each of the individual processes. Further, known solutions do not take advantage of role and responsibility specialization within a software development organization, which serve to drive effectiveness of the security solution and provide the necessary checks and balances within the security process. In addition, the current systems either focus primarily on the development of new software applications and/or systems or vulnerabilities and/or security issues in pre-existing systems, however; they fail to address the problems together in a combined process/system.

Additionally, the current frameworks, methodologies, processes, and best practices do not provide for a dedicated team to prioritize, analyze and/or streamline the security issues surrounding the overall process. In most instances, the role is combined with either the software development team or as part of the separate information security or risk organization. Such combined functionality creates possible conflicts of interest within a role (e.g., software development weighing security issues versus the need to implement a design), thereby reducing the overall effectiveness of the security process.

Therefore, a need exists to develop a comprehensive, overarching software security process that addresses all of the concerns and vulnerabilities present in software and governs the individual security processes and practices. In this regard, the desired system should define specific security practices and the timing for application of the practices within the overall software development lifecycle. Further, the desired system should address the security of both new software systems and pre-existing software systems. Additionally, the desired software security system should take advantage of role specialization, such as security specialization, to increase effectiveness and limit conflicts of interest within the design process. In addition, the desired system should provide feedback mechanisms to measure the effectiveness of the system and provide for continuous improvement.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus, and systems and computer program products are described herein that provide for a comprehensive software security system. The overarching software security system described and claimed herein provides for a system that address all of the concerns and vulnerabilities present at the design level (i.e., new software applications) and the production level (i.e., pre-existing software applications) associated with software. Additionally, the system governs the individual security processes and practices. The software security system defines specific security practices and the timing for application of the practices within the overall software development lifecycle. Additionally, the disclosed software security system takes advantage of role specialization, such as security specialization, to increase effectiveness and limit conflicts of interest within the design process.

A method for providing for software security defines one embodiment of the invention. The method includes determining a design risk score for a software system design and determining a design risk category for the software system design based on the design risk score. The method further includes processing the software system through a plurality of design risk category-specific security processes based on the determination of the design risk category.

The method may additionally include releasing the software system into production, determining a production risk score for production use of the software system and determining a production risk category for the software system based on the production risk score. Such methods also include, processing the software system through a plurality of production risk category-specific security processes for a lifecycle of the software system based on the determination of the production risk category. In one such specific embodiment, determining the production risk score includes implementing the design risk score as the production risk score.

According to specific embodiments of the method, the plurality of design risk category-specific security processes may be two or more of process scheduling, information security review, architecture review, design review, code review, automated source code scan, automated vulnerability scan, ethical hack, secondary automated vulnerability scan or security test case assessment. In still further specific embodiment of the method, the plurality of production risk category-specific security processes may be two or more of process scheduling, automated source code scan, automated vulnerability scan, ethical hack, or secondary automated vulnerability.

In other specific embodiments of the method, determining a design risk category further includes determining a design risk category for the software system design based on the design risk score, wherein the design risk category is one of high design risk, medium design risk or low design risk. In such embodiments, processing the software system through a plurality of production risk category-specific security processes further includes processing the software through process scheduling, information security review, architecture review, design review, code review, automated source code scan, automated vulnerability scan, ethical hack, secondary automated vulnerability scan and security test case assessment based on the determination of the high design risk category. Additionally, in such embodiments, processing the software system through a plurality of design risk category-specific security processes further includes processing the software through process scheduling, information security review, architecture review, design review, code review, automated source code scan, automated vulnerability scan, secondary automated vulnerability scan and security test case assessment based on the determination of the medium design risk category. Also, in such embodiments, processing the software system through a plurality of design risk category-specific security processes further includes processing the software through process scheduling, design review, code review, automated source code scan, secondary automated vulnerability scan and security test case assessment based on the determination of the low design risk category.

In still further embodiments of the method, determining a production risk category further includes determining a production risk category for the software system based on the production risk score, wherein the production risk category is one of high design risk, medium design risk or low design risk. In such embodiments, processing the software system through a plurality of production risk category-specific security processes further includes processing the software through process scheduling, automated source code scan, automated vulnerability scan, ethical hack, and secondary automated vulnerability scan based on the determination of the high production risk category. Additionally, in such embodiments, processing the software system through a plurality of production risk category-specific security processes further includes processing the software through process scheduling, automated source code scan, automated vulnerability scan, and secondary automated vulnerability scan based on the determination of the medium production risk category. Also, in such embodiments, processing the software system through a plurality of production risk category-specific security processes further includes processing the software through process scheduling, automated source code scan, and secondary automated vulnerability scan based on the determination of the low design risk category.

An additional method for providing for software security defines another embodiment of the invention. The method includes determining, at a computer processor, a design risk score for a software system design, determining a design risk category for the software system design based on the design risk score and processing the software system through a plurality of design risk category-specific security processes based on the determination of the design risk category.

An apparatus for providing software security defines yet another embodiment of the invention. The apparatus includes a computing platform including at least one processor and a memory. The apparatus further includes a software security module stored in the memory and executable by the least one processor. The module includes at least one risk scoring routine configured to determine a design risk score for one of software system design or software system production use, and a plurality of risk-score based software security processing flows. One of the plurality of software security processing flows is selected to be applied to design or production use of the software system based on the risk-score.

In specific embodiments of the apparatus, the risk scoring routine is further configured to determine a risk category for one of the software system design or the software system production use based on the risk score and one or more risk category thresholds. In such embodiments, the risk scored-based software security processing flows are further defined as risk category-based software security processing flows. Further, one of the plurality of software security processing flows is selected to be applied to design or production use of the software system based on the risk-category.

In other specific embodiments of the apparatus, the software security module further comprises a security issue tracker configured to track issue resolution of issues that are identified during implementation of the selected design or production software security processing flow. In other related embodiments of the apparatus, the software security module further comprises a software security database configured to store design software security processing flow data and production software security processing flow data. The design software security processing flow data and the production software security processing flow data may include processing flow records and issue remediation data.

A computer program product including a computer-readable medium provides for yet another embodiment of the invention. The medium includes a first set of codes for causing a computer to determine a design risk score for a software system design. The medium additionally includes a second set of codes for causing a computer to determine a design risk category for the software system design based on the design risk score. Additionally, the medium includes a third set of codes for causing a computer to apply a design software security processing flow to the software system design based on the design risk category.

To the accomplishment of the foregoing and related ends, the one or more embodiments include the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a flow diagram of a comprehensive, overarching software security system that includes both design security and production security, in accordance with one embodiment of the present invention;

FIG. 2 is a flow diagram highlighting the flow for high risk design security processing, in accordance with an embodiment of the present invention;

FIG. 3 is a flow diagram highlighting the flow for medium risk design security processing, in accordance with one embodiment of the present invention;

FIG. 4 is a flow diagram highlighting the flow for low risk design security processing, in accordance with an embodiment of the present invention;

FIG. 5 is a flow diagram highlighting the flow for high risk production security processing, in accordance with an embodiment of the present invention;

FIG. 6 is a flow diagram highlighting the flow for medium risk production security processing, in accordance with an embodiment of the present invention;

FIG. 7 is a flow diagram highlighting the flow for low risk production security processing, in accordance with an embodiment of the present invention;

FIG. 8 is a block diagram of an apparatus for software security, in accordance with yet another embodiment of the invention; and

FIG. 9 is a block diagram depicting the interplay between business organizations in relation to software security processing, in accordance with an embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems or apparatus that may include a number of devices, components, modules, and the like. It is to be understood and appreciated that the various systems or apparatus may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

Thus, methods, apparatus, and systems described herein that provide for a comprehensive software security system. The overarching software security system described and claimed herein provides for a system that address all of the concerns and vulnerabilities present at the design level (i.e., new software applications) and the production level (i.e., pre-existing software applications) associated with software. Additionally, the system governs the individual security processes and practices. The software security system defines specific security practices and the timing for application of the practices within the overall software development lifecycle. Additionally, the disclosed software security system takes advantage of role specialization, such as security specialization, to increase effectiveness and limit conflicts of interest within the design process.

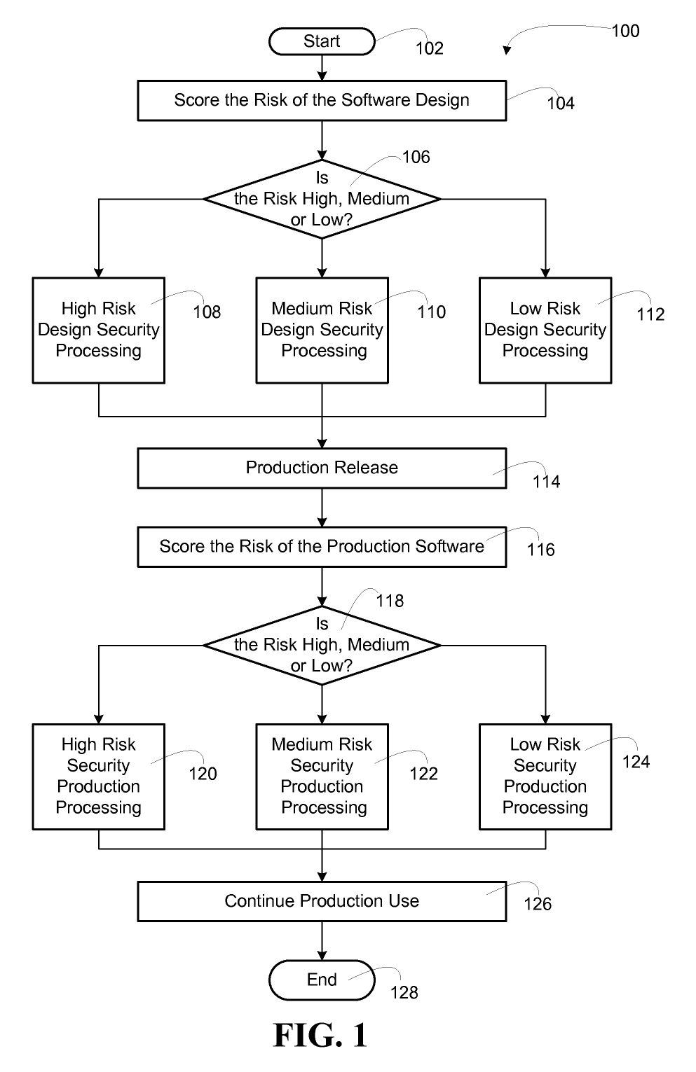

Referring to FIG. 1, a high-level flow diagram is depicted of a comprehensive method 100 for software security, in accordance with an embodiment of the present invention. The comprehensive nature of the software security system described in relation to FIG. 1 provides for security processing at both the design-level (i.e., new software applications) and the production-level (i.e., pre-existing software applications). The design-level and production-level security assessment and remediation processes use multiple reviews and security assessments to provide a multi-layered defense and in-depth approach to software security. The complexity of today's software applications/systems is such that a single approach does not provide the necessary security assurance and, as such, embodiments of the present invention provide for a multiple assessment/review/test approach, each assessment/review/test having differing focus to ensure security.

Additionally, the software security system provides risk based scoring analysis at the onset of both design and production security processing to ensure that the proper level of security is applied based on the risk score as a means of minimizing risk and maximizing efficiency/reward. The outcome of the risk score defines which set of assessments/reviews/tests will be applied to the software system.

The method of FIG. 1 is initiated at start Event 102. The method assumes that the software is a new software system or a pre-existing software system requiring modifications. At Event 104, risk scoring of the software design process occurs prior to implementing design security assessment/review/test processing. In accordance with embodiments of the present invention, risk scoring involves defining security characteristics associated with the software system and assigning a risk level based on the security characteristics. For example, security characteristics may include, but are not limited to, non-public information (e.g., confidential information and/or proprietary information) included in or required by the software system; functionality subject to fraud or identity theft (e.g., user authentication/verification and/or financial transactions); significant user interaction through multiple user inputs (e.g., user forums, bulletin boards or the like) and the like.

In certain embodiments of the invention design risk scoring may provide for a user to provide inputs to a risk scoring algorithm which subsequently calculates a risk score or otherwise determines the design risk category associated with the software system. In other embodiments, design risk scoring may be conducted manually based on the design security characteristics associated with the software system.

In accordance with one embodiment of the invention the design risk score may be a numeric score, an alphanumeric score or an alphabetic score. In such embodiments predetermined thresholds may be implemented to determine the category of risk associated with a risk score. For example, if numeric risk scoring is employed, a score at or above 85 may signify high risk, a score between 70 and 85 may signify medium risk and a score at or below 70 may signify low risk. Additionally, in such embodiments, a weighting system may be employed to ensure that more important design security characteristics are given proper significance in the design risk scoring process.

In other embodiments of the invention, the inclusion or absence of a security characteristic may define which design risk category is applied to the software system. For example, in one embodiment of the invention, if the software system includes or otherwise utilizes non-public information, or the software system provides functions susceptible to fraud or identity theft, or the software system provides significant user interaction through multiple user inputs, the software system may be deemed to be design high risk. Additionally, if the software system accepts data inputs from users but does meet any of the security characteristics for high risk, the software system may be deemed to be design medium risk. Further, software applications/systems that are primarily or completely informational and do not meet any of the security characteristics for high or medium risk, may be deemed to be design low risk.

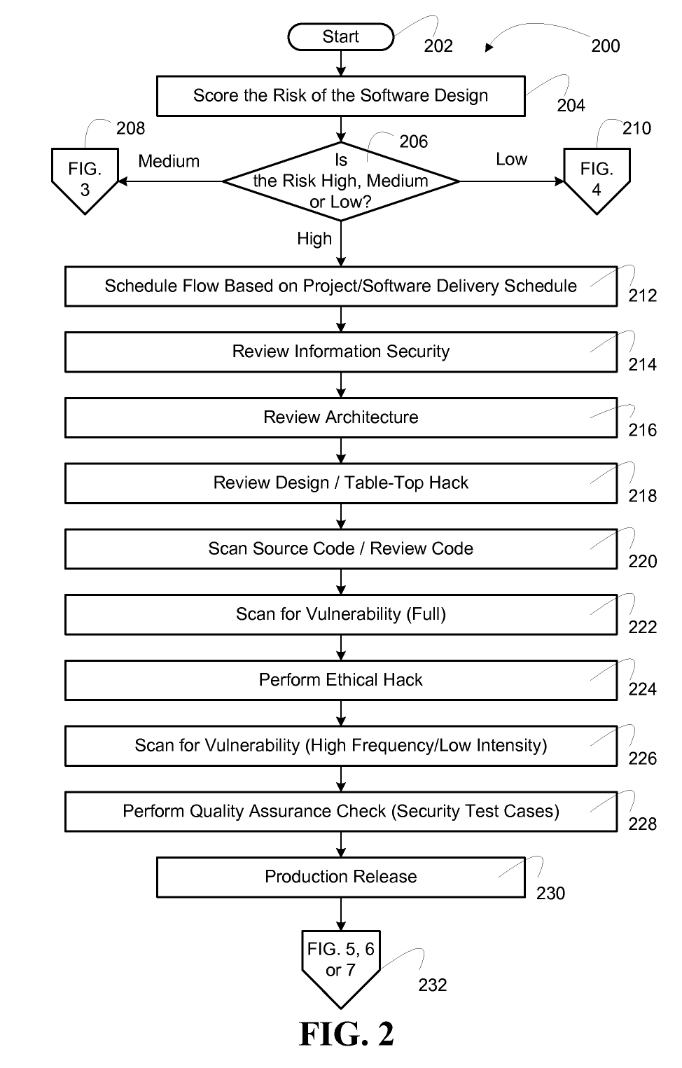

Thus, at Event 106, based on the design risk scoring described above, a determination is made as to whether the software design poses a high risk, a medium risk or a low risk. The determination of the design risk category defines which assessment/review/test processes are assigned to the software system/application. If a determination is made that the software system is high risk, at Event 108, the software system undergoes high risk design security processing. If a determination is made that the software system is medium risk, at Event 110, the software system undergoes medium risk design security processing. If a determination is made that the software system is low risk, at Event 112, the software system undergoes low risk design security processing. Examples of the high risk, medium risk, and low risk design security processing are shown and described in relation to FIGS. 2, 3 and 4; respectively.

At Event 114, once the design security processing is completed and one or more production readiness reviews have been completed, including addressing any outstanding security issues and remediation, the software system is released for production use. Once production use is authorized and initiated, the software system enters the security production processing flow described by Events 116-126.

At Event 116, risk scoring of the software production process occurs prior to implementing production security assessment/review/test processing. In certain embodiments of the invention the risk scoring applied at the design-level will apply to the processing-level, thus, obviating the need to perform separate risk scoring assessment at the production-level. However, in other embodiments of the invention, in which risk scoring was not conducted at the design-level for specific software currently in production or in instances in which separate risk scoring is required, risk scoring is conducted prior to production security processing. It should be noted that separate risk scoring may be required if the security characteristics associated with production are different than the security characteristics associated with design, if the risk categories are different or for any other valid reason.

In certain embodiments of the invention production risk scoring may provide for a user to provide inputs to a risk scoring algorithm which subsequently calculates a risk score or otherwise determines the production risk category associated with the software system. In other embodiments, production risk scoring may be conducted manually based on the production security characteristics associated with the software system.

In accordance with one embodiment of the invention the production risk score may be a numeric score, an alphanumeric score or an alphabetic score. In such embodiments predetermined thresholds may be implemented to determine the category of risk associated with a production risk score. For example, if numeric risk scoring is employed, a score at or above 85 may signify high risk, a score between 70 and 85 may signify medium risk and a score at or below 70 may signify low risk. Additionally, in such embodiments, a weighting system may be employed to ensure that more important production security characteristics are given proper significance in the production risk scoring process.

In other embodiments of the invention, the inclusion or absence of a production security characteristic may define which production risk category is applied to the software system. For example, in one embodiment of the invention, if the software system includes or otherwise utilizes non-public information, or the software system provides functions susceptible to fraud or identity theft, or the software system provides significant user interaction through multiple user inputs, the software system may be deemed to be production high risk. Additionally, if the software system accepts data inputs from users but does meet any of the security characteristics for high risk, the software system may be deemed to be production medium risk. Further, software applications/systems that are primarily or completely informational and do not meet any of the security characteristics for high or medium risk, may be deemed to be production low risk.

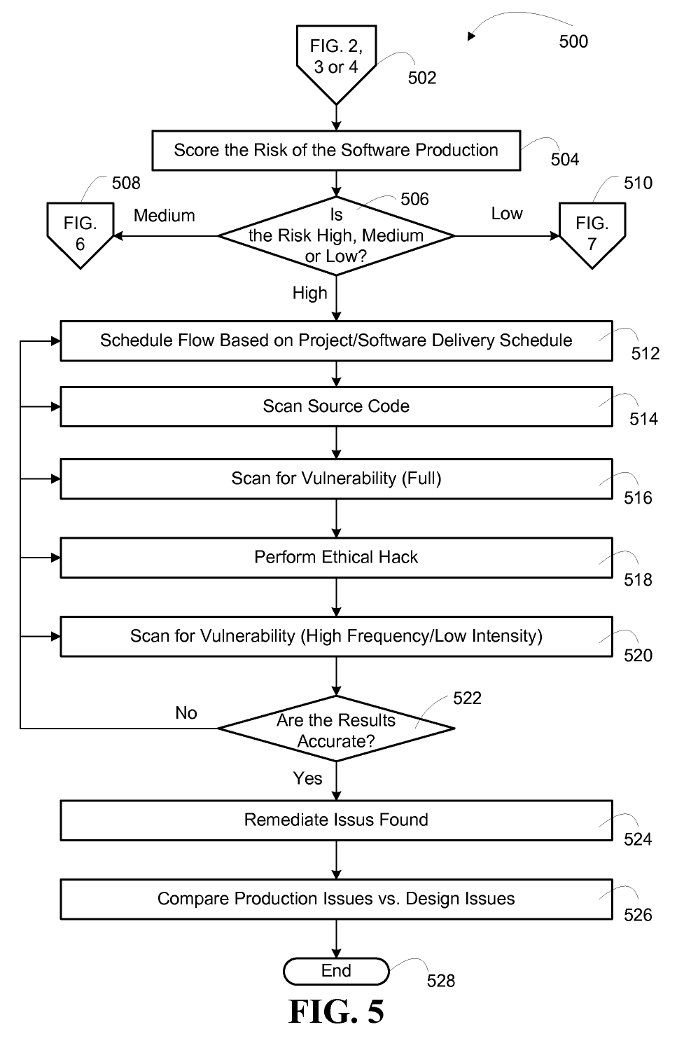

Thus, at Event 118, based on the production risk scoring described above, a determination is made as to whether the production use of the software poses a high risk, a medium risk or a low risk. The determination of the risk category defines which production assessment/review/test processes are assigned to the software system/application. If a determination is made that the software system is high risk, at Event 120, the software system undergoes high risk production security processing. If a determination is made that the software system is medium risk, at Event 122, the software system undergoes medium risk production security processing. If a determination is made that the software system is low risk, at Event 124, the software system undergoes low risk design security processing. Examples of the high risk, medium risk, and low risk design security processing are shown and described in relation to FIGS. 5, 6 and 7; respectively.

At Event 126, production processing continues once the production security processing is completed. Additionally, according to some embodiments production processing may continue after or in unison with, assuring that the results of the processing are accurate, remediating issues found during processing and comparing production security issues to design security issues. At Event 128, the process is completed. It should be noted that the production security process is an ongoing process that occurs at any point in time during the life of the software system. The production security processing may occur based on a predetermined schedule and/or based on a triggering event, such as identification of vulnerability, an attack or the like or on an as-needed basis.

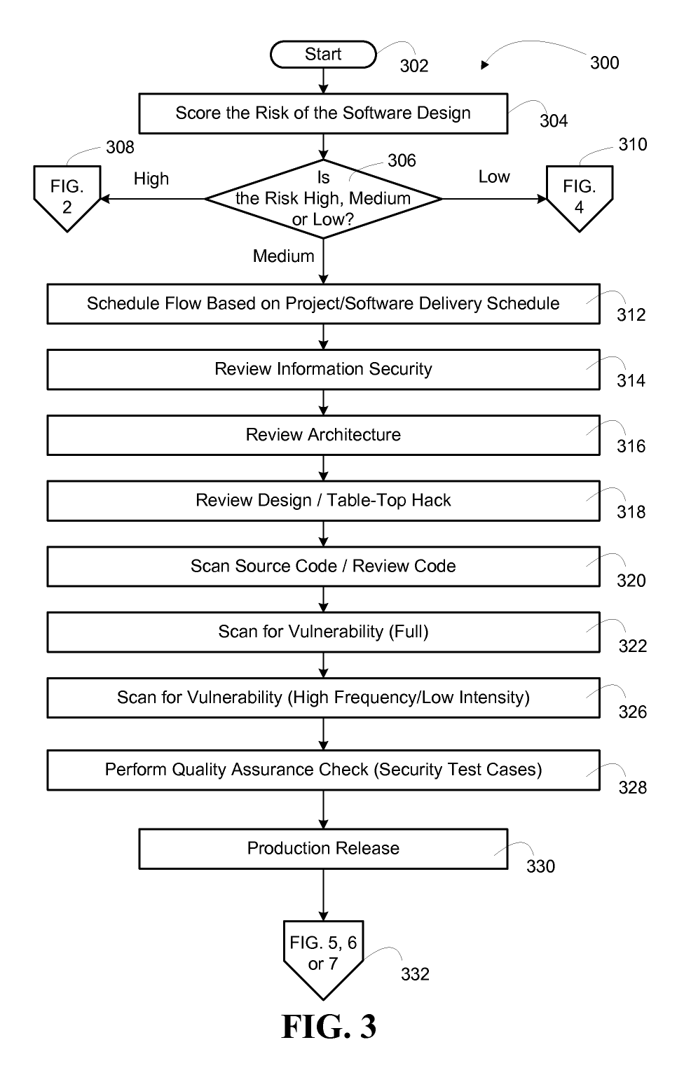

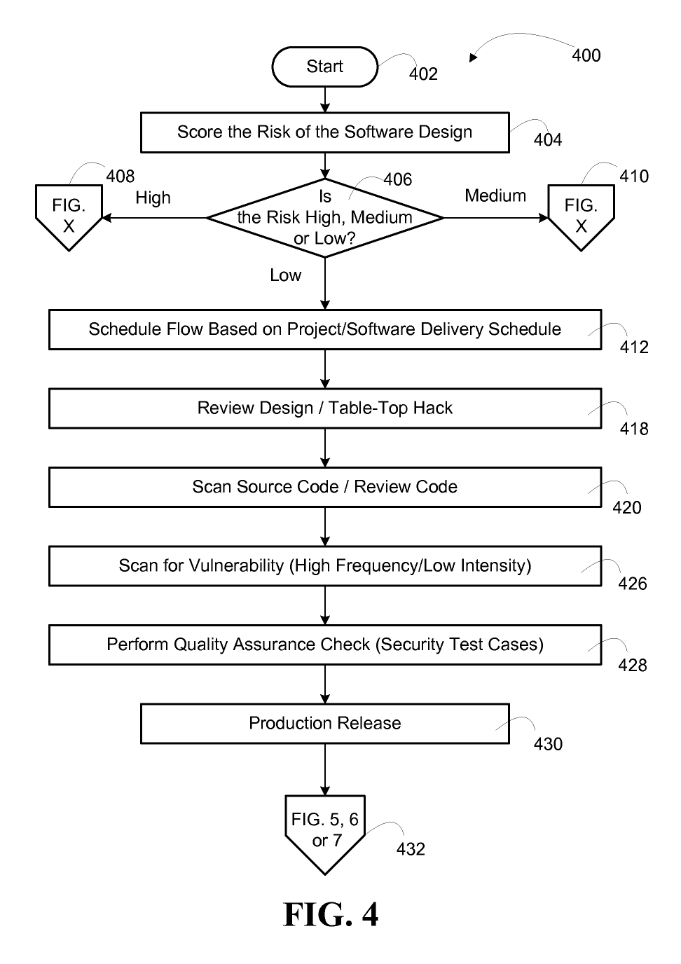

Referring to FIG. 2 a flow diagram is depicted of a method 200 for the design assessment/review/test processes that are undertaken if the risk score determines that the software being designed is high risk software; in accordance with an embodiment of the present invention. The method 200 is initiated at start Event 202. The method assumes that the software is a new software system or a pre-existing software system requiring modifications. At Event 204, risk scoring of the software design process occurs prior to implementing design security assessment/review/test processing. Risk scoring may occur in accordance to any of the procedures and/or methods described in relation to FIG. 1. At Event 206, based on the design risk scoring described above, a determination is made as to whether the software design poses a high risk, a medium risk or a low risk. The determination of the design risk category defines which assessment/review/test processes are assigned to the software system/application. If a determination is made that the software system is medium risk, at off-page marker 208, the processing flow detailed in FIG. 3 ensues. If a determination is made that the software system is low risk, at off-page marker 210, the processing flow detailed in FIG. 4 ensues.

If a determination is made that the software system is high risk, the flow shown and described in FIG. 2 ensues. At Event 212, the security assessment processes included in the project development lifecycle, such as, reviews, analysis, scan, tests or the like, are scheduled based on the requirements of the project delivery schedule. Scheduling of the security assessment processes based on project deliverable scheduling ensures that sufficient time is allocated for remediation of security issues that are uncovered during the assessment processes. In accordance with one embodiment of the invention, a dedicated software security team schedules the necessary security assessment processes (Events 214-228) that occur in the project development lifecycle. In specific embodiments of the invention, the dedicated software security team may schedule the security assessment processes in conjunction with other dedicated teams, such as a software development team, a vulnerability assessment team or the like.

In addition to, or in conjunction with, scheduling security assessment processes, a risk analysis may be performed that includes ancillary risks associated with the software being designed or modified. The ancillary risks may be a business risk, legal risk, financial risk or the like. In accordance with an embodiment of the present invention, the ancillary risk analysis may be performed by a dedicated team, such as business control/monitoring/risk team or the like.

At Event 214, information security is reviewed. The review of information security, which may be an ongoing process that lasts for the duration of the design security assessment process, may include a review of requirements, architecture and design from an information security perspective. In one embodiment of the invention, the information security review is conducted by a dedicated team, such as an information security team or the like.

At Event 216, the developed software system architecture is reviewed. The review of the architecture provides feedback on potential security threats related to the architecture in addition to other architecture related security issues. In one embodiment of the invention, the architecture review is conducted by a dedicated team, such as an architecture team or the like.

At Event 218, high level and low level review of the design is performed to identify design and/or security flows. In certain embodiments, the design review may include simulated hacking exercises, otherwise referred to as “table-top hacking” exercises, to assess possible security issues that may be exposed by the design. The simulated hacking exercises involve step-by-step assessment of the screen/form design along with the support system design to identify potential points of weakness or unexpected results in the software design. In one embodiment of the invention, the design review is conducted by a dedicated team, such as a software security team. In specific embodiments of the invention, the dedicated software security team may perform the design review in conjunction with other dedicated teams, such as a software development team or the like.

In addition to or in conjunction with the design review, test cases may be built, such as security test cases or the like for the software system. In one embodiment of the invention, the test cases are built by a dedicated team, such as a testing and quality assurance team or the like.

At Event 220, an automated source code scan and code review is performed. The automated code scan may be completed once the design has reached code integration phase and may be implemented using custom source code scanning tools and/or industry standard tools. The automated source code scan is conducted to identify potential security issues and vulnerabilities. In one embodiment, the automated scans are ongoing processes that occur throughout the remainder of the security assessment process. Additionally, a source code review is performed to ensure adherence to security checklists and business standards. In accordance with an embodiment of the present invention, all issues related to the automated source code scan and code review are tracked for remediation by one or more dedicated teams, such as, the software security team, the software development team or the like.

At Event 222, an automated vulnerability scan is performed. The automated vulnerability scan may be completed once the design of the software has matured to the point where it is feature-sable and ready for human testing. The automated vulnerability scan may be performed using custom tools or industry standard tools. The vulnerability scanning tools serve to interact with the software system such that they simulate user interaction, e.g., engaging keys, inputting data, activating (i.e., clicking-on) links and the like. Such interaction provides for identification of security vulnerabilities and functional flaws in the software system. In one embodiment of the invention, the automated vulnerability scan is performed by a dedicated team, such as a vulnerability testing team or the like. In other embodiments of the present invention, all issues related to the automated vulnerability scan are tracked for remediation by one or more dedicated teams, such as, the software security team, the software development team or the like.

At Event 224, an ethical hack is conducted. An ethical hack is a manual process conducted by a security testing expert or the like. The ethical hack serves to identify flaws and security gaps that are incapable of being identified by the automated source code scans and/or the vulnerability scan. The security testing expert interacts with the software system in a similar fashion to how a real attacker/hacker would, attempting to exploit the system to commit fraud and/or expose confidential information. In one embodiment of the invention, the ethical hack is performed by a dedicated team, such as the vulnerability assessment team or the like. In further specific embodiments, issues related to the ethical hack are tracked for remediation by one or more dedicated teams, such as, the software security team, the software development team or the like.

At Event 226, a secondary vulnerability scan is performed, such as a high frequency/low intensity vulnerability scan or the like. A custom vulnerability scan tool or a tool similar to the tool implemented at Event 222 is implemented to assess the security of the software system. The secondary vulnerability tool is a less invasive tool that rapidly exercises the software system as a final check before production readiness. The tool provides for more repetitions of specific tests within the tool and/or shorter overall process duration. In one embodiment of the invention, the secondary vulnerability scan is conducted by a dedicated team, such as a vulnerability assessment team or the like. In further specific embodiments, issues related to the secondary vulnerability scan are tracked for remediation by one or more dedicated teams, such as, the software security team, the software development team or the like.

At Event 228, quality assurance checks are performed. Security test cases, such as those identified at Event 212 or the like, are implemented to provide another level of security assurance for the software system. The quality assurance checks to insure that the software program does what it is purported to do and does not expose the software to security or vulnerability issues. In one embodiment of the invention, the quality assurance check is conducted by a dedicated team, such as a testing and quality assurance team or the like. In further specific embodiments, issues related to the secondary vulnerability scan are tracked for remediation by one or more dedicated teams, such as, the software security team, the software development team or the like.

At Event 230, the software system is released to production. The release of the system to production is predicated on approval, such as approval by a dedicated team, such as the release management team or the like. Once the software system has been released into production the system enters the production security process flow as described in FIG. 5, 6 or 7, as depicted by off-page reference 232. It should also be noted that, in accordance with specific embodiments, prior to production release, regularly scheduled production reviews may be conducted that address security issues, remediation associated with the security issues and, ultimately, the decision process for release of the software system into production.

Referring to FIG. 3 a flow diagram is illustrated of a method 300 for the design assessment/review/test processes that are undertaken if the risk score determines that the software being designed is medium risk software; in accordance with an embodiment of the present invention. In accordance with the method described in relation to FIGS. 2 and 3, the medium risk flow differs from the high risk flow by the omission of the ethical hack event (Event 224 of FIG. 2).

The method 300 is initiated at start Event 302. The method assumes that the software is a new software system or a pre-existing software system requiring modifications. At Event 304, risk scoring of the software design process occurs prior to implement design security assessment/review/test processing. Risk scoring may occur in accordance to any of the procedures and/or methods described in relation to FIG. 1. At Event 306, based on the design risk scoring described above, a determination is made as to whether the software design poses a high risk, a medium risk or a low risk. The determination of the design risk category defines which assessment/review/test processes are assigned to the software system/application. If a determination is made that the software system is high risk, at off-page marker 308, the processing flow detailed in FIG. 2 ensues. If a determination is made that the software system is low risk, at off-page marker 310, the processing flow detailed in FIG. 4 ensues.

If a determination is made that the software system is high risk, the flow shown and described in FIG. 3 ensues. At Event 312, the security assessment processes included in the project development lifecycle, such as, reviews, analysis, scan, tests or the like are scheduled based on the requirements of the project delivery schedule. Event 312 of FIG. 3 replicates Event 212 of FIG. 2 and, as such, the discussion of Event 212 equally applies to Event 312.

At Event 314, information security is reviewed. Event 314 of FIG. 3 replicates Event 214 of FIG. 2 and, as such, the discussion of Event 214 equally applies to Event 314. Further, at Event 316, the developed software system architecture is reviewed. Event 316 of FIG. 3 replicates Event 216 of FIG. 2 and, as such, the discussion of Event 216 equally applies to Event 316.

At Event 318, high level and low level review of the design, including simulated/table-top hacks, are performed to identify design and/or security flows. Event 318 of FIG. 3 replicates Event 218 of FIG. 2 and, as such, the discussion of Event 218 equally applies to Event 318. Further, at Event 220, an automated source code scan and code review is performed. Event 320 of FIG. 3 replicates Event 220 of FIG. 2 and, as such, the discussion of Event 220 equally applies to Event 320.

At Event 322, an automated vulnerability scan is performed. Event 322 of FIG. 3 replicates Event 222 of FIG. 2 and, as such, the discussion of Event 222 equally applies to Event 322. Further, at Event 326, a secondary vulnerability scan is performed, such as a high frequency/low intensity vulnerability scan or the like. Event 326 of FIG. 3 replicates Event 226 of FIG. 2 and, as such, the discussion of Event 226 equally applies to Event 326. Next, at Event 328, quality assurance checks are performed. Event 328 of FIG. 3 replicates Event 228 of FIG. 2 and, as such, the discussion of Event 228 equally applies to Event 328.

Once medium risk design security assessment processing is completed, at Event 330, the software system is released to production. Once the software system has been released into production the system enters the production security process flow as described in FIG. 5, 6 or 7, as depicted by off-page reference 332.

Referring to FIG. 4 a flow diagram is depicted of a method 400 for the design assessment/review/test processes that are undertaken if the risk score determines that the software being designed is low risk software; in accordance with an embodiment of the present invention. In accordance with the method described in relation to FIGS. 2 and 4, the low risk flow differs from the high risk flow by the omission of the ethical hack event (Event 224 of FIG. 2), the information security review, (Event 214 of FIG. 2), the architecture review (Event 216 of FIG. 2) and the full automated vulnerability scan (Event 222 of FIG. 2).

The method 400 is initiated at start Event 402. The method assumes that the software is a new software system or a pre-existing software system requiring modifications. At Event 404, risk scoring of the software design process occurs prior to implement design security assessment/review/test processing. Risk scoring may occur in accordance to any of the procedures and/or methods described in relation to FIG. 1. At Event 406, based on the design risk scoring described above, a determination is made as to whether the software design poses a high risk, a medium risk or a low risk. The determination of the design risk category defines which assessment/review/test processes are assigned to the software system/application. If a determination is made that the software system is high risk, at off-page marker 408, the processing flow detailed in FIG. 2 ensues. If a determination is made that the software system is medium risk, at off-page marker 410, the processing flow detailed in FIG. 3 ensues.

If a determination is made that the software system is low risk, the flow shown and described in FIG. 4 ensues. At Event 412, the security assessment processes included in the project development lifecycle, such as, reviews, analysis, scan, tests or the like are scheduled based on the requirements of the project delivery schedule. Event 412 of FIG. 4 replicates Event 212 of FIG. 2 and, as such, the discussion of Event 212 equally applies to Event 412.

At Event 418, high level and low level review of the design, including simulated hacks, are performed to identify design and/or security flows. Event 418 of FIG. 4 replicates Event 218 of FIG. 2 and, as such, the discussion of Event 218 equally applies to Event 418. Further, at Event 220, an automated source code scan and code review is performed. Event 420 of FIG. 4 replicates Event 220 of FIG. 2 and, as such, the discussion of Event 220 equally applies to Event 420.

At Event 426, a secondary vulnerability scan is performed, such as a high frequency/low intensity vulnerability scan or the like. Event 426 of FIG. 4 replicates Event 226 of FIG. 2 and, as such, the discussion of Event 226 equally applies to Event 426. Next, at Event 428, quality assurance checks are performed. Event 428 of FIG. 4 replicates Event 228 of FIG. 2 and, as such, the discussion of Event 228 equally applies to Event 428.

Once low risk design security assessment processing is completed, at Event 430, the software system is released to production. Once the software system has been released into production the system enters the production security process flow as described in FIG. 5, 6 or 7, as depicted by off-page reference 432.

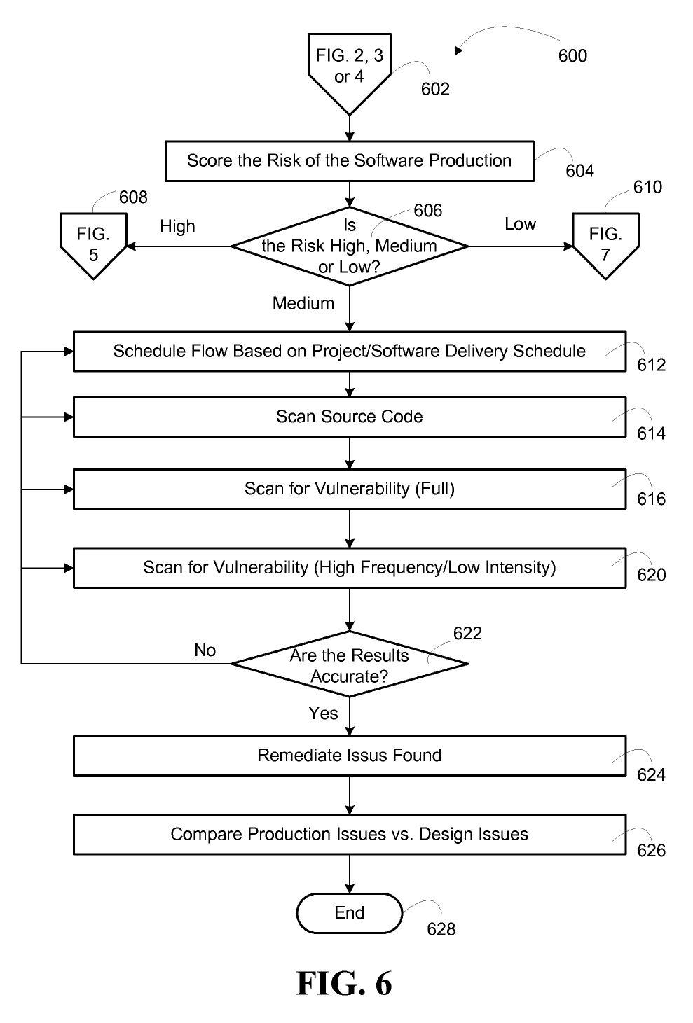

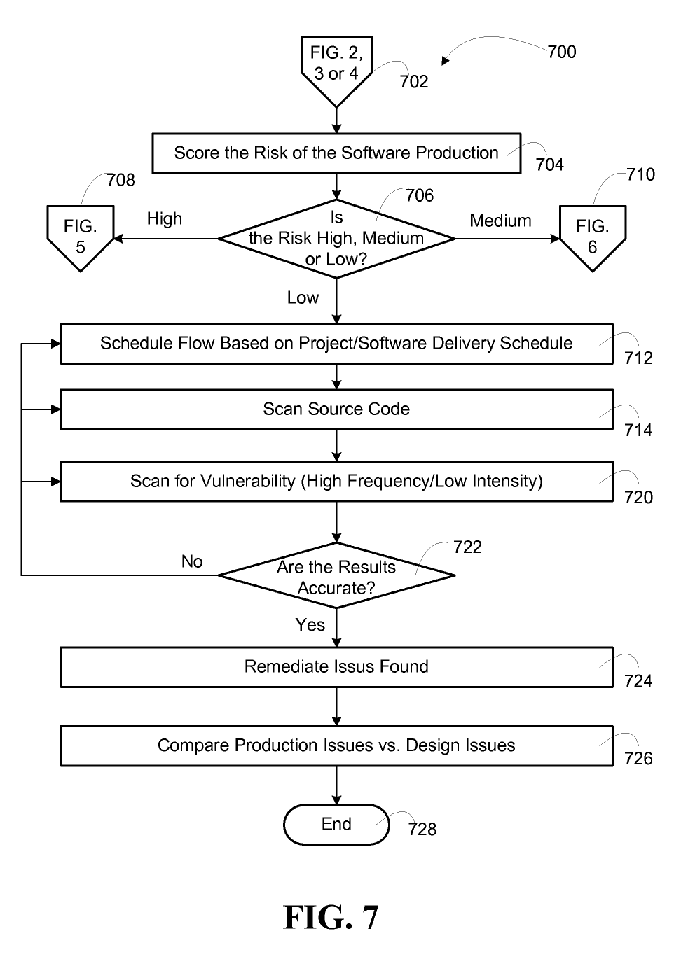

Referring to FIG. 5, depicted is a flow diagram of a method 500 for production assessment/review/test security processes that are undertaken if the production risk score determines that the production software is high risk software; in accordance with an embodiment of the present invention. The method 500 continues from previously described design security assessment processes discussed in relation to FIGS. 2, 3 and 4, as noted by off-page reference 502. At Event 504, risk scoring of the software security production process occurs prior to implementing production security assessment/review/test processing. Risk scoring may occur in accordance to any of the procedures and/or methods described in relation to FIG. 1. At Event 506, based on the production risk scoring described above, a determination is made as to whether the production use of software poses a high risk, a medium risk or a low risk. The determination of the production risk category defines which assessment/review/test processes are assigned to the software system/application. If a determination is made that the production use of the software system is medium risk, at off-page marker 508, the processing flow detailed in FIG. 6 ensues. If a determination is made that the production use of the software system is low risk, at off-page marker 510, the processing flow detailed in FIG. 7 ensues.

It should be noted that in certain embodiments of the invention the criteria used to risk score at the design-level is identical or essentially identical to the criteria used at the production-level. In such instances, the need to perform separate risk scoring and risk category determination at the production-level is obviated, since the risk score and risk category determined at the design-level would equally apply to the production-level. However, if the criteria used to determine risk score at the production-level differs from the risk score criteria used at the design-level, a separate risk score and risk category determination is performed, as shown and described in relation to FIGS. 5, 6 and 7

If a determination is made that the production use of software system is high risk, the flow shown and described in FIG. 5 ensues. At Event 512, the security assessment processes, such as, reviews, analysis, scan, tests or the like are scheduled based on predetermined time intervals or dates. In order to minimize scheduling impact consideration may be given to production system change schedules and in-progress software development projects. In accordance with one embodiment of the invention, one or more dedicated teams, such as a software security team, a vulnerability assessment team or the like, schedules the necessary security assessment processes (Events 514-520) that occur in the production phase.

At Event 514, an automated source code scan is performed at a predetermined interval, such as a monthly interval or the like, and continue throughout the production lifetime of the software system. The automated code review may be implemented using custom source code scanning tools and/or industry standard tools. The automated source code scan is conducted to identify potential security issues and vulnerabilities that have arisen during production and/or over time as new security issues and vulnerabilities arise. In accordance with an embodiment of the present invention, all issues related to the automated source code scan are tracked for remediation by one or more dedicated teams, such as, the software security team or the like.

At Event 516, an automated vulnerability scan is performed at a predetermined interval, such as annually or the like and continue throughout the production lifetime of the software system. The automated vulnerability scan may be performed using custom tools or industry standard tools and serve to identify potential security issues and vulnerabilities that have arisen during production and/or over time as new security issues and vulnerabilities arise. In one embodiment of the invention, the automated vulnerability scan is performed by a dedicated team, such as a vulnerability testing team or the like. In other embodiments of the present invention, all issues related to the automated vulnerability scan are tracked for remediation by one or more dedicated teams, such as, the software security team or the like.

At Event 518, an ethical hack is conducted on a predetermined interval, such as annually or the like. In one embodiment of the invention, the ethical hack is scheduled and conducted in conjunction with the automated vulnerability scan (Event 516). An ethical hack is a manual process conducted by a security testing expert or the like. The ethical hack serves to identify flaws and security gaps that are incapable of being identified by the automated source code scans and/or the vulnerability scan. The security testing expert interacts with the software system in a similar fashion to how a real attacker/hacker would, trying to exploit the system to commit fraud and/or expose confidential information. In one embodiment of the invention, the ethical hack is performed by a dedicated team, such as the vulnerability assessment team or the like. In further specific embodiments, issues related to the ethical hack are tracked for remediation by a dedicated team, such as, the software security team or the like.

At Event 520, a secondary vulnerability scan is performed, such as a high frequency/low intensity vulnerability scan or the like on a predetermined interval, such as weekly or the like. A custom vulnerability scan tool or a tool similar to the tool implemented at Event 516 is implemented to assess the security of the software system. The secondary vulnerability tool is a less invasive tool that rapidly exercises the software system. In one embodiment of the invention, the secondary vulnerability scan is conducted by a dedicated team, such as a vulnerability assessment team or the like. In further specific embodiments, issues related to the secondary vulnerability scan are tracked for remediation by a dedicated team, such as, the software security team or the like.

At Decision 522, a determination is made as to the accuracy of one or more of the assessment/reviews and/or tests performed during production processing. If the accuracy is in question, the process may return to the specific assessment/review or test for re-performance of the assessment/review or test (Events 514-520) and/or the schedule may be adjusted (Event 512), such as more frequent assessments/reviews or tests based on the inaccurate results. At Event 524, any security related issues identified during production security assessment processing are remediated by one or more dedicated teams and, at Event 526, any production security issues are compared to design security issues. Comparison of production versus design issues may leverage remediation performed at the design level with remediation at the production level. At Event 528, the process ends after the lifetime of production use had been exhausted.

Referring to FIG. 6, a flow diagram is illustrated of a method 600 for production security assessment/review/test processes that are undertaken if the risk score determines that the software being designed is medium risk software; in accordance with an embodiment of the present invention. In accordance with the method described in relation to FIGS. 5 and 6, the medium risk flow differs from the high risk flow by the omission of the ethical hack event (Event 518 of FIG. 5).

The method 600 continues from previously described design security assessment processes discussed in relation to FIGS. 2, 3 and 4, as noted by off-page reference 602. At Event 604, risk scoring of the software security production process occurs prior to implementing production security assessment/review/test processing. Risk scoring may occur in accordance to any of the procedures and/or methods described in relation to FIG. 1. At Event 606, based on the production risk scoring described above, a determination is made as to whether the production use of software poses a high risk, a medium risk or a low risk. The determination of the production risk category defines which assessment/review/test processes are assigned to the software system/application. If a determination is made that the production use of the software system is high risk, at off-page marker 608, the processing flow detailed in FIG. 5 ensues. If a determination is made that the production use of the software system is low risk, at off-page marker 610, the processing flow detailed in FIG. 7 ensues.

If a determination is made that the software system is medium risk, the flow shown and described in FIG. 6 ensues. At Event 612, the security assessment processes, such as, reviews, analysis, scan, tests or the like for the production processing are scheduled based on predetermined time intervals or dates. Event 612 of FIG. 6 replicates Event 512 of FIG. 5 and, as such, the discussion of Event 512 equally applies to Event 612.

At Event 614, an automated source code scan is performed. Event 614 of FIG. 6 replicates Event 514 of FIG. 5 and, as such, the discussion of Event 514 equally applies to Event 614. Further, at Event 616, an automated vulnerability scan is performed. Event 616 of FIG. 6 replicates Event 516 of FIG. 5 and, as such, the discussion of Event 516 equally applies to Event 616.

Further, at Event 620, a secondary vulnerability scan is performed, such as a high frequency/low intensity vulnerability scan or the like. Event 620 of FIG. 6 replicates Event 520 of FIG. 5 and, as such, the discussion of Event 520 equally applies to Event 620.

At Decision 622, a determination is made as to the accuracy of one or more of the assessment/reviews and/or tests performed during production processing. If the accuracy is in question, the process may return to the specific assessment/review or test for re-performance of the assessment/review or test (Events 614-620) and/or the schedule may be adjusted (Event 612), such as more frequent assessments/reviews or tests based on the inaccurate results. At Event 624, any security related issues identified during production security assessment processing are remediated by one or more dedicated teams and, at Event 626, any production security issues are compared to design security issues. Comparison of production versus design issues may leverage remediation performed at the design level with remediation at the production level. At Event 628, the process ends after the lifetime of production use had been exhausted.

Referring to FIG. 7 a flow diagram is depicted of a method 700 for production assessment/review/test processes that are undertaken if the risk score determines that the production use of software is low risk; in accordance with an embodiment of the present invention. In accordance with the method described in relation to FIGS. 5 and 7, the low risk flow differs from the high risk flow by the omission of the ethical hack event (Event 518 of FIG. 5) and the full automated vulnerability scan (Event 516 of FIG. 5).

The method 700 continues from previously described design security assessment processes discussed in relation to FIGS. 2, 3 and 4, as noted by off-page reference 702. At Event 704, risk scoring of the software security production process occurs prior to implementing production security assessment/review/test processing. Risk scoring may occur in accordance to any of the procedures and/or methods described in relation to FIG. 1. At Event 706, based on the production risk scoring described above, a determination is made as to whether the production use of software poses a high risk, a medium risk or a low risk. The determination of the production risk category defines which assessment/review/test processes are assigned to the software system/application. If a determination is made that the production use of the software system is high risk, at off-page marker 708, the processing flow detailed in FIG. 5 ensues. If a determination is made that the production use of the software system is medium risk, at off-page marker 710, the processing flow detailed in FIG. 6 ensues.

If a determination is made that the software system is low risk, the flow shown and described in FIG. 7 ensues. At Event 712, the security assessment processes, such as, reviews, analysis, scan, tests or the like for the production processing are scheduled based on predetermined time intervals or dates. Event 712 of FIG. 7 replicates Event 512 of FIG. 5 and, as such, the discussion of Event 512 equally applies to Event 712.

At Event 714, an automated source code scan is performed. Event 714 of FIG. 7 replicates Event 514 of FIG. 5 and, as such, the discussion of Event 514 equally applies to Event 714.

Further, at Event 720, a secondary vulnerability scan is performed, such as a high frequency/low intensity vulnerability scan or the like. Event 720 of FIG. 7 replicates Event 520 of FIG. 5 and, as such, the discussion of Event 520 equally applies to Event 720.

At Decision 722, a determination is made as to the accuracy of one or more of the assessment/reviews and/or tests performed during production processing. If the accuracy is in question, the process may return to the specific assessment/review or test for re-performance of the assessment/review or test (Events 712-720) and/or the schedule may be adjusted (Event 712), such as more frequent assessments/reviews or tests based on the inaccurate results. At Event 724, any security related issues identified during production security assessment processing are remediated by one or more dedicated teams and, at Event 726, any production security issues are compared to design security issues. Comparison of production versus design issues may leverage remediation performed at the design level with remediation at the production level. At Event 728, the process ends after the lifetime of production use had been exhausted.

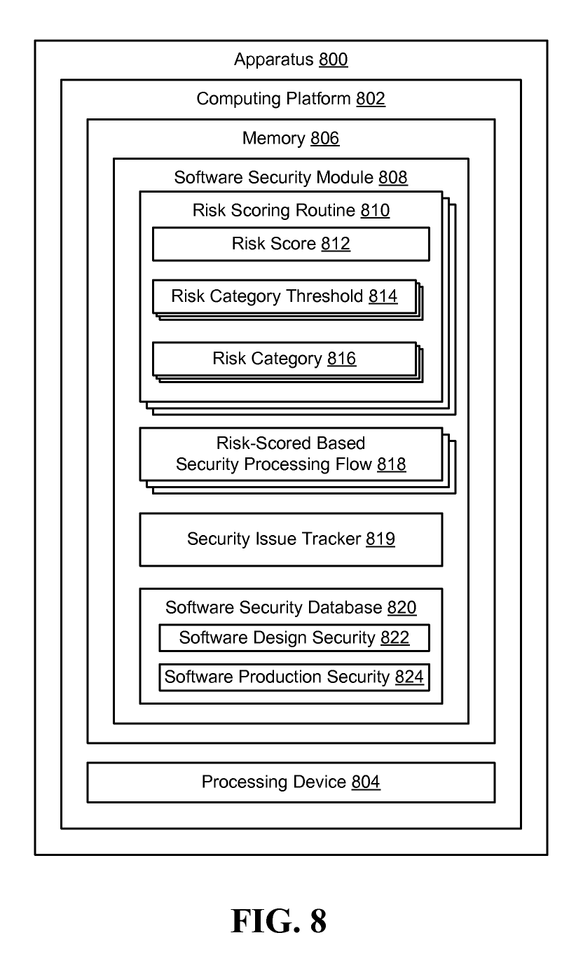

Turning the reader's attention to FIG. 8, a block diagram representation of an apparatus 800 for software security is provided, in accordance with present embodiments of the invention. The apparatus 800 may comprise any type of computerized, device, such as personal computer, a laptop computer, a server or the like. The apparatus 800 includes computer platform 802 that can receive and execute routines and applications. Computer platform 800 includes memory 806, which may comprise volatile and nonvolatile memory such as read-only and/or random-access memory (RAM and ROM), EPROM, EEPROM, flash cards, or any memory common to computer platforms. Further, memory 806 may include one or more flash memory cells, or may be any secondary or tertiary storage device, such as magnetic media, optical media, tape, or soft or hard disk.

Further, computer platform 802 also includes processor device 804, which may be an application-specific integrated circuit (“ASIC”), or other chipset, processor, logic circuit, or other data processing device. Processor 804 may include various processing subsystems embodied in hardware, firmware, software, and combinations thereof, that enable the functionality of apparatus 800 and the operability of the apparatus 800 on a network.

Memory 806 of apparatus 800 includes a software security module 808. In accordance with present embodiments of the invention, software security module is configured to provide a comprehensive, overarching software security system that includes both design-level and production-level security processing.

The software security module 808 may include one or more risk scoring routines 810 configured to determine a risk score 812 for software design and/or production use of software. In one embodiment, one risk scoring routine 810 is implemented to determine design-level security risk score 812 and another distinct risk scoring routine 810 is implemented to determine production-level security risk score 812. In a further embodiment, one risk scoring routine may suffice for determining both design-level and production-level risk scores. In certain embodiments of the invention design and/or production risk scoring may provide for a user to provide inputs to the risk scoring which subsequently calculates a risk score or otherwise determines the design and/or production risk category associated with the software system. As noted previously, in other embodiments, risk scoring may be conducted manually based on the security characteristics associated with the software system, obviating the need for risk scoring routines 810.

In accordance with one embodiment of the invention the design and/or production risk score 812 may be a numeric score, an alphanumeric score or an alphabetic score. In such embodiments predetermined risk thresholds 814 may be implemented to determine the risk category 816 associated with a design and/or production risk score. For example, if numeric risk scoring is employed, a score at or above 85 may signify a high risk category, a score between 70 and 85 may signify medium risk and a score at or below 70 may signify low risk. Additionally, in such embodiments, a weighting system may be employed to ensure that more important design and/or production security characteristics are given proper significance in the design and/or production risk scoring process.

Additionally, software security module 808 includes risk category-based security processing flows 818. The flow 818 defines the assessments, reviewed and/or tests that are to be performed for a specified risk category. In one embodiment of the invention, a high, medium and low risk category security processing flow 818 is provided. In another embodiment of the invention, separate security processing flows 818 are provided for design-level software security and production-level software security.

The software security module 808 also may include a security issue tracker 819 that tracks the resolution and remediation of identified security issues to ensure that security issues are rectified prior to production or during production. In addition, the tracker ensures that the resolution/remediation is dually recorded and stored in database 820 for future reference and the like.

Software security module 808 additionally may include software security database 820 that comprises software design security data 822, such as records of previous design-level security processing and details of any remediation or corrective actions performed in conjunction with the design-level security processing. The database may additionally include production-level security data 824, such as records of ongoing production-level security processing, including schedules for required assessments, reviews, tests and/or the like.

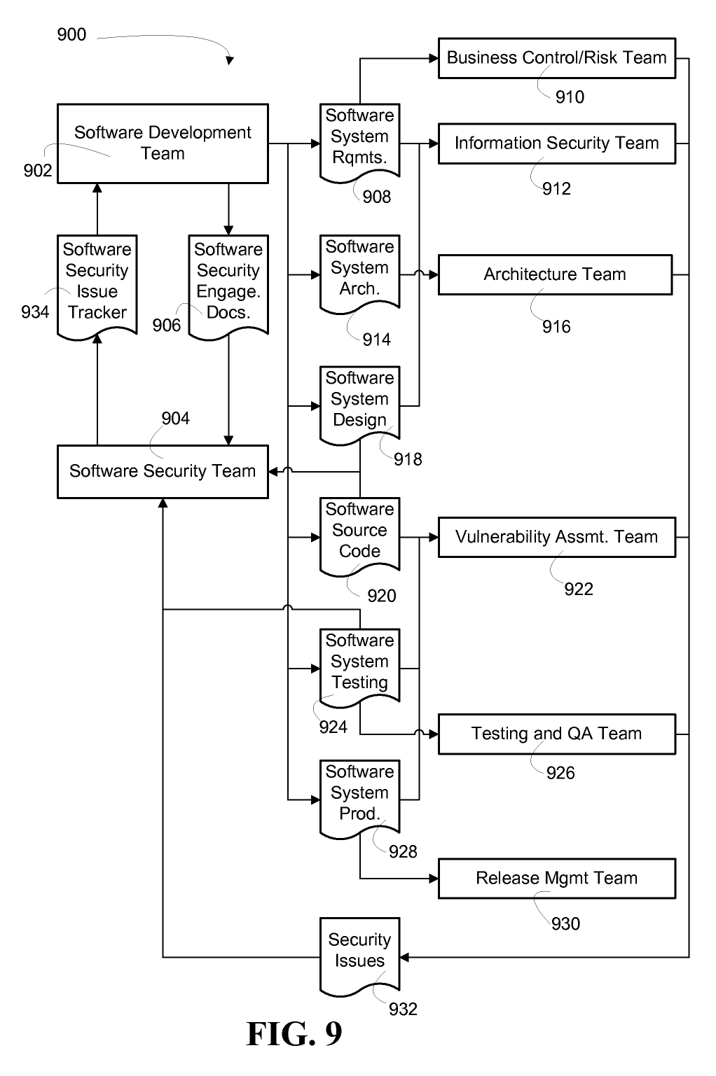

FIG. 9 provides a flow diagram 900 of exemplary role responsibilities in a software security system, in accordance with embodiments of the present invention. The software security system of the present invention may benefit from dividing responsibilities among different roles/teams to leverage existing functions within a business or organization and to provide a necessary system for checks and balances, such that assessments, reviews, tests and the like are not performed by the same entity responsible for developing the software system.

Software Development Team 902 is responsible for designing/building the software system and remediating any issues identified by the Software Security Team 904. Designing/building the software system may entail completing a Security Engagement Packet 906 that includes the data outlining the project and identifying security characteristics that may impact the risk score and risk category determination. The completed Security Engagement Packet 906 may be delivered to the Software Security Team 904 for review and approval.

The Software Security Team 904 provides the focus to the overall software security process. The Software Security team leverages the partnerships and capabilities across the enterprise/business to deliver secure software systems. In addition, the Software Security Team 904 provides for a single point of contact for analysis and evaluation of identified security issues.

Additionally, designing/building the software system may include completing Software System Requirements 908 that encompasses both the business requirements and the technical requirements. Upon completion by the Software Development Team 902, the Software System Requirements 908 may be subsequently implemented by the Business Control/Management/Risk Team 910 and/or the Information Security Team 912 for risk and/or security review. The Business Control/Management/Risk Team 910 provides a risk analysis covering ancillary risks, such as business risk, legal risk and financial risks that may be balanced against the identified security risks. The Information Security Team 912 provides information management and protection perspective to the security process; protecting against improper information disclosure and access.

Designing/building the software system may also include Software System Architecture 914 that encompasses both the software architecture and technical infrastructure. Upon completion by the Software Development Team 902, the Software System Architecture may be subsequently implemented by the Information Security Team 912 and the Architecture Team 916 for risk and security reviews. The Architecture Team 916 reviews the technical architecture and identifies potential security issues related to the architecture and infrastructure. In this regard, the Architecture Team 916 determines the impact of changes introduced by new software system development on the larger infrastructure and the potential for exposing or creating security issues.

Also, the designing/building of the software system by the Software Development Team 902 includes the Software System Design 918. This design includes both the high level and low level designs. If the design includes user interaction with the software system the design may also include wireframe designs of the user interface screens or the like. Upon completion, the Software System Design is implemented by the Information Security Team 912 and the Software Security Team 904 for risk and security review.

Additionally, the Software Development Team 902 designs/builds the Software Source Code 920. The Software Source Code 920 is implemented by the Vulnerability Assessment Team 922 and the Software Security Team 904 as inputs to the automated source code scanning tool and for manual code review. The Vulnerability Assessment Team 922 provides assessment services including, but not limited to, code scanning and review, application testing and scanning, and ethical hack testing. The services provided by the Vulnerability Assessment Team 922 are performed external to the Software Development Team 902 to allow for necessary checks and balances.

Moreover, the Software Development Team 902 designs/builds the Software System for Testing 924. The Software System for Testing 924 is used by the Vulnerability Assessment Team 922 and the Software Security team 904 as inputs to the automated application scanning tools and the ethical hack testing. In addition, the Software System for Testing 924 is implemented by the Testing and Quality Assurance Team 926 as inputs to QA testing processes. The Testing and Quality Assurance Team 926 provides testing services external from the Software Development Team 902. In addition to functional and error testing, the Testing and Quality Assurance Team 926 applies specific security test cases to test boundary conditions and other improper inputs.

Lastly, the Software Development Team 902 designs/builds the Software System for Production 928. The Software System for Production 928 is used by the Vulnerability Assessment Team 922 for secondary automated vulnerability scans, such as high frequency/low intensity scans or the like. Additionally, the Software System for Production is used by the Release Management Team 930 for rollout into production use.

Security Issues 932 that are identified by the Business Control Management Team 910, the Information Security Team 912, the Architecture Team 916, the Vulnerability Management Team 922, and/or the Testing and Quality Assurance Team 926 are provided to the Software Security Team 904 for analysis and evaluation.

Additionally, Software Security Issue Tracker 934, which is produced by the Software Security Team 904, delivers security issues to the Software Development Team and provides tracking of the security issues.

Thus the methods, apparatus, and systems and computer program products heretofore described provide for a comprehensive software security system. The overarching software security system described and claimed herein provides for a system that address all of the concerns and vulnerabilities present at the design level (i.e., new software applications) and the production level (i.e., pre-existing software applications) associated with software. Additionally, the system governs the individual security processes and practices. The software security system defines specific security practices and the timing for application of the practices within the overall software development lifecycle. Additionally, the disclosed software security system takes advantage of role specialization, such as security specialization, to increase effectiveness and limit conflicts of interest within the design process.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for providing for software security, the method comprising:
determining a design risk score for a software system design;
determining a design risk category for the software system design based on the design risk score; and
processing the software system through a plurality of design risk category-specific security processes based on the determination of the design risk category.

2. The method of claim 1, further comprising:
releasing the software system into production;
determining a production risk score for production use of the software system;
determining a production risk category for the software system based on the production risk score; and
processing the software system through a plurality of production risk category-specific security processes for a lifecycle of the software system based on the determination of the production risk category.

3. The method of claim 1, wherein processing the software system through a plurality of design risk category-specific security processes further defines the plurality of design risk category-specific security processes as two or more of process scheduling, information security review, architecture review, design review, code review, automated source code scan, automated vulnerability scan, ethical hack, secondary automated vulnerability scan or security test case assessment.

4. The method of claim 1, wherein determining a design risk category further comprises determining a design risk category for the software system design based on the design risk score, wherein the design risk category is one of high design risk, medium design risk or low design risk.

5. The method of claim 4, wherein processing the software system through a plurality of production risk category-specific security processes further comprises processing the software through process scheduling, information security review, architecture review, design review, code review, automated source code scan, automated vulnerability scan, ethical hack, secondary automated vulnerability scan and security test case assessment based on the determination of the high design risk category.

6. The method of claim 4, wherein processing the software system through a plurality of design risk category-specific security processes further comprises processing the software through process scheduling, information security review, architecture review, design review, code review, automated source code scan, automated vulnerability scan, secondary automated vulnerability scan and security test case assessment based on the determination of the medium design risk category.

7. The method of claim 4, wherein processing the software system through a plurality of design risk category-specific security processes further comprises processing the software through process scheduling, design review, code review, automated source code scan, secondary automated vulnerability scan and security test case assessment based on the determination of the low design risk category.

8. The method of claim 2, wherein determining a production risk score for production use of the software system further comprises implementing the design risk score as the production risk score.

9. The method of claim 2, wherein processing the software system through a plurality of production risk category-specific security processes further defines the plurality of production risk category-specific security processes as two or more of process scheduling, automated source code scan, automated vulnerability scan, ethical hack, or secondary automated vulnerability.

10. The method of claim 2, wherein determining a production risk category further comprises determining a production risk category for the software system based on the production risk score, wherein the production risk category is one of high design risk, medium design risk or low design risk.

11. The method of claim 10, wherein processing the software system through a plurality of production risk category-specific security processes further comprises processing the software through process scheduling, automated source code scan, automated vulnerability scan, ethical hack, and secondary automated vulnerability scan based on the determination of the high production risk category.

12. The method of claim 10, wherein processing the software system through a plurality of production risk category-specific security processes further comprises processing the software through process scheduling, automated source code scan, automated vulnerability scan, and secondary automated vulnerability scan based on the determination of the medium production risk category.

13. The method of claim 10, wherein processing the software system through a plurality of production risk category-specific security processes further comprises processing the software through process scheduling, automated source code scan, and secondary automated vulnerability scan based on the determination of the low design risk category.

14. A method for providing for software security, the method comprising:
determining, at a computer processor, a design risk score for a software system design;
determining a design risk category for the software system design based on the design risk score; and
processing the software system through a plurality of design risk category-specific security processes based on the determination of the design risk category.

15. The method of claim 14, further comprising:
releasing the software system into production;
determining, at a computer processor, a production risk score for production use of the software system;
determining a production risk category for the software system based on the production risk score; and
processing the software system through a plurality of production risk category-specific security processes for a lifecycle of the software system based on the determination of the production risk category.

16. The method of claim 14, wherein processing the software system through a plurality of design risk category-specific security processes further defines the plurality of design risk category-specific security processes as two or more of process scheduling, information security review, architecture review, design review, code review, automated source code scan, automated vulnerability scan, ethical hack, secondary automated vulnerability scan or security test case assessment.

17. The method of claim 14, wherein determining a design risk category further comprises determining a design risk category for the software system design based on the design risk score, wherein the design risk category is one of high design risk, medium design risk or low design risk.

18. An apparatus for providing software security, the apparatus comprising:
a computing platform including at least one processor and a memory;
a software security module stored in the memory, executable by the least one processor and including,
at least one risk scoring routine configured to determine a design risk score for one of software system design or software system production use, and
a plurality of risk-score based software security processing flows, wherein one of the plurality of software security processing flows is selected to be applied to design or production use of the software system based on the risk-score.

19. The apparatus of claim 18, wherein the risk scoring routine is further configured to determine a risk category for one of the software system design or the software system production use based on the risk score and one or more risk category thresholds.

20. The apparatus of claim 19, wherein the risk scored-based software security processing flows are further defined as risk category-based software security processing flows, wherein one of the plurality of software security processing flows is selected to be applied to design or production use of the software system based on the risk-category.

21. The apparatus of claim 18, wherein the software security module further comprises a security issue tracker configured to track issue resolution of issues that are identified during implementation of the selected design or production software security processing flow.

22. The apparatus of claim 18, wherein the software security module further comprises a software security database configured to store design software security processing flow data and production software security processing flow data.

23. The apparatus of claim 18, wherein the design software security processing flow data and the production software security processing flow data include processing flow records and issue remediation data.

24. A computer program product comprising:
a computer-readable medium comprising:
a first set of codes for causing a computer to determine a design risk score for a software system design;
a second set of codes for causing a computer to determine a design risk category for the software system design based on the design risk score; and
a third set of codes for causing a computer to apply a design software security processing flow to the software system design based on the design risk category.

25. The computer program product of claim 24, wherein the medium further comprises:
a fourth set of codes for causing a computer to determine a production risk score for production use of the software system;
a fifth set of codes for causing a computer to determine a production risk category for the software system based on the production risk score; and
a sixth set of codes for causing a computer to apply a production software security processing flow to production use of software system based on the production risk category.
